(19) United States
(12) Patent Application Publication
(10) Pub. No.: US 2006/0026073 A1
(43) Pub. Date: Feb. 2, 2006

(54) Methods and Systems for Managing Card Programs and Processing Card Transactions

(76) Inventors: Edwin R. Kenny JR., Norcross, GA (US); Robert A. Campbell, Norcross, GA (US)

Correspondence Address: EXPERT FINANCIAL SYSTEMS, LLC, 6630 BAY CIRCLE, NORCROSS, GA, 30071, US

(21) Appl. No.: 11/163,590

(22) Filed: Oct. 24, 2005

(51) Int. Cl. G06Q 20/00

(52) U.S. Cl. 705/16; 705/14

(57) ABSTRACT

Methods and systems are provided for processing Card transactions. The Cards and Card Programs are configured on a Host System by a Client and transactions are received at a Host System. Issuers of Cards and their Program Groups are configured on the Host System. Acquirers of Card transactions and their Program Groups are configured on the Host System. An Issuer and Acquirer associated with singular Card transactions may or may not belong to the same Client. The Card transactions carry associated data relevant to the Card Type and transaction type captured and identified by the Host System for proper Transaction Set build and ultimate Card transaction processing based on the relevant Issuer and Acquirer set choices. A Web Interface is provided for Clients, their designees, and Cardholders.

Herein are described methods and systems for managing and processing Card transactions. The Card transactions contain associated data relevant to the Card Issuer, transaction Acquirer, Card Type and transaction type captured and analyzed by the Host System for proper ultimate Card Transaction Set processing based on the relevant Issuer and Acquirer choices.

### FIELD OF THE INVENTION

This invention relates generally to Card transaction processing and Card Program development and management systems.

Definition List 1

| Term | Definition |
|---|---|
| Acquirer | A Location configured in the Host System |
| | that accepts Cards for transaction author- |
| | ization. This entity can be a brick and |
| | mortar Location, mail & telephone order |
| | house, an Internet based merchant, a vir- |
| | tual store, Card transaction batch |
| | schemas, and/or Card Program schemas. |
| | These Acquirers can be regionalized, |
| | chained, and/or grouped by Program Group |
| | naming. Acquirers may often work with |
| | Issuers and their Card Programs. |
| Agent | An entity that sells Cards and related |
| | services on behalf of one or more |
| | Distributors. |
| Card | A usually flat stiff small piece of |
| | plastic-like material bearing account |
| | information relevant to the Card holder |
| | and Card Issuer, the information being |
| | printed, embossed, and/or encoded thereon. |
| | Cards have Stored Value and banking |
| | related functionality associated with |
| | them. Cards may have information encoded |
| | with magnetic strip, bar code, RFID |
| | (Radio Frequency ID) and/or memory chip |
| | technologies. Cards are used mainly as an |
| | authorizing media for Card account |
| | transactions. |
| Card | A Client developed Card based solution |
| Program | utilizing the Host System for implementa- |
| | tion, processing, maintenance, delivery, |
| | design, and data storage for said |
| | solution. |
| Card Types | A sequential range of Card numbers that |
| | are assigned a Type value that must be |
| | assigned prior to any valid Card trans- |
| | action authorization occurring. Card |
| | Types are often generically referred to |
| | as gift, loyalty, reward, private label |
| | credit, custom loyalty, ATM/Debit, custom |
| | ATM/Debit, multi-client, credit, event |
| | days, and custom. A Location must be |
| | authorized in the Host System database to |
| | accept specific Card Type transactions. |
| Client | A bank, marketing company, insurance |
| | company, independent sales organization, |
| | affinity group, Card Distributor, mer- |
| | chant services provider, retailer, |
| | reseller, or any other entity that util- |
| | izes the Host System for Card Program |
| | design, development, implementation, |
| | deployment, and management services |
| | and/or Card transaction processing |
| | services. |
| Distributor | An entity that markets, usually as a |
| | wholesaler, Cards and related services to |
| | their customers or channels of distri- |
| | bution. |
| Host | A computer-readable storage medium having |
| System | a computer-readable program embodied |
| | therein for directing operation of the |
| | computer system including a communi- |
| | cations system, a processor, and a stor- |
| | age device, wherein the computer-readable |
| | program includes instructions for oper- |
| | ating the system to develop, manage, and |
| | maintain Card Programs, to process Card |
| | transactions, to write, retrieve and |
| | store in a relational database Distri- |
| | butor, Agent, Client, Locations, Card- |
| | holder, Card, Card Type, Card Program, |
| | Program Group, and any other Client needs |
| | based data hierarchy schema, and to write, |
| | store, and retrieve Card transaction His- |
| | tory. An Internet Web Interface with |
| | applicable user functionality including |
| | input, queries, and user defined time |
| | length based reporting, is provided by |
| | the Host System for Support, and a plur- |
| | ality of Distributors, Agents, Clients, |
| | chains, Locations, and Cardholders, and |
| | any other Client needs based data |
| | hierarchy schema. |
| Inbound | A transaction data string of varied |
| Transaction | formats from varied sources directed to |
| | and recognized by the Host System for |
| | processing. |
| Issuer | A Location configured in the Host System |
| | that develops, deploys, maintains, dis- |
| | tributes, and/or manages Card Programs, |
| | and/or provides Cards for use as trans- |
| | action authorizing media. |
| Location | Acquirer and/or Issuer retail site, |
| | marketing position, Card Program defini- |
| | tion, or other Client needs-driven entity |
| | or method for assignment of Program Group |
| | values for Card Programs in the Host |
| | System database. |
| Open | A collection of computer modems, gateways, |
| Network | switches, Terminals, and hosts that route |
| | electronic Card transaction strings, typi- |
| | cally from bank Card merchant services |
| | Terminals and ATM machines ultimately to |
| | the appropriate bank card processor for |
| | transaction authorization. |
| Program | Named sets of fees, rates, dates, dor- |
| Groups | mancy periods, event transactions, and |
| | event days configured by the Client in |
| | the Host system database and associated |
| | with Client Locations to rapidly custo- |
| | mize Card Programs. Program Groups of the |
| | same name may be utilized by a plurality |
| | of Clients and/or Locations. |
| Stored | Any number of gift, loyalty, reward, |
| Value | discount, rebate, prepaid debit, points, |
| | voucher, coupon, demand deposit, miles, |
| | bonus dollars, cash back, minutes, etc., |
| | of varying values associated with a Card |
| | account for accumulation and redemption |
| | by means of the Host System. |
| Terminal | An electronic device used to capture, |
| | batch and transmit Card transactions via |
| | dial up modems, Internet, wireless, or |
| | host to host communications. The trans- |
| | actions are routed through Open and Third |
| | Party Networks or directly to the Host |
| | System. The electronic devices may in- |
| | clude and/or utilize Magnetic Strip |
| | Readers, bar code scanners, RFID tech- |
| | nology, and smart card chip readers. The |
| | devices can be stand alone units, PC |
| | based software applications, Cellular |
| | Phone or other wireless enabled devices, |
| | or middleware software residing in a |
| | computer host system. |
| Third Party | A collection of computer modems, gateways, |
| Network | switches, Terminals, and hosts that route |
| | electronic Card transaction strings to |
| | the Host System for processing. These |
| | networks route Card transaction strings |
| | to the Host System using either a Host |
| | System Web Services XML messaging format, |
| | or another format specification of the |
| | Third Party Network. Often these networks |
| | are utilized for closed loop or non-Open |
| | Network transaction communications. |
| Transaction | A group of more than one Card transaction |
| Set | with the original Inbound Transaction |
| | string values determining the ultimate |
| | contents of the set. |
| Web | A Host System collection of HTML, DHTML, |
| Interface | and JavaScript applications supported by |
| | standard web browsers. The web pages are |
| | either forms or query output types driven |
| | by CGI, ASP, JSP, and PHP methods. Forms |
| | are provided that Host System support |
| | personnel, Clients, their designees, and |
| | Cardholders use for data input, data |
| | retrieval, and query reports. Queries |
| | from the Host System database can be made |
| | from Client, Card, Location, Distributor, |
| | Agent, Program Groups, and dates values |
| | inputs. |

### BACKGROUND OF THE INVENTION

This invention relates generally to Card transaction processing. More specifically, this invention relates to methods and systems that allow Clients the ability to rapidly deploy customized, managed Card Programs that are configurable down to Client Location levels if desired.

Currently, conventional Card transaction processing is handled in a traditional legacy manner that is typically very flat or two dimensional designs and in simplest form, just Card numbers to a fixed schedule. This traditional, legacy approach involves an issuer of traditional Cards, typically being a bank, a marketing company, or a Stored Value Card services entity, defining a schedule usually containing fees, dates, and rates. Fees may be charged to the Cardholder for various transactions, dates apply for card and program expirations, and rates of various loyalty rewards programs are applied in points and discounts type database buckets or tables. The traditional Card issuer then associates that set schedule with a sequential range of Card numbers which usually includes an appended check digit on the end. This ranging typically involves round lots of 50,000 or more Card numbers. In such a flat database environment issuance of truly relational Card offerings are non existent in Card services and transaction processing markets.

Because this conventional flat legacy data structure is inflexible by inherent design, users of the traditional existing transaction processing methods are not easily able to deploy Card offerings that offer new or unique features.

There is, therefore, a general need in the art of Card services and transaction processing for methods and systems that provide greater depth, scope, and flexibility to Acquirers, Issuers, and Clients with the ability to rapidly deploy customizable Card Programs without sacrificing existing functionality in the art of traditional, legacy transaction processing.

### BRIEF SUMMARY OF THE INVENTION

This invention alleviates these shortcomings of conventional Card transaction processing systems. All uses of this invention make use of a Host System having a capacity to interface with other hosts, such as with Issuers, Acquirers, Client, and Open Network systems and their customers, through bitmap and XML based messaging schema specifications. The Host System contains a relational database that stores Client choices in various database tables that allow the computer programs utilized by the Host System to identify and process a Transaction Set based on the information contained in the transaction string received by the Host System from a third party host and the stored Client choices. The Card transactions are treated differently based on this varying Acquirer and/or Issuer data which provides improved depth, scope, and flexibility of Card Programs to Acquirers, Issuers, and Clients, among multiple other advantages that will be evident to those studying the invention.

Embodiments of the invention may occur based on Client requirements and uses of the Host System properties by utilization of any or all of the following: Web Interface user forms, bitmap and XML message specifications, and user documentation describing the Host System properties for various Card Program designs.

In one embodiment, there is a plurality of Card Programs for a plurality of Clients utilizing the Host System for marketing needs driven Stored Value Card Programs. Since marketing plans and needs are often driven by geographical and demographical statistics, the Host System allows a Client to configure a plurality of regions, stores, divisions, chains, subsidiaries, or any grouping schema choice desired with different assignments of Program Groups which, because of the different assignment would normally contain at least one different value for fees, rates, dates, event days, and event transactions for a Card Program. This means a singular Card may obtain a plurality of Transaction Sets and those associated values held within the Host System database of different Program Groups on the same date for the same transaction type based on the varied transaction Location choices.

Another embodiment is a plurality of Card Programs of Client issued Cards utilized by Cardholders as a payment vehicle for goods and services. Clients who use these types of Card Programs issue Stored Value Cards where Cardholders may gain various different incentives and values for the Card usage at a plurality of Client Locations. In this embodiment Acquiring Locations and the Issuer are associated with the same Client within the Host System database.

In another embodiment, a plurality of Card Programs of a plurality of Clients issue Cards utilized by Card holders as a payment vehicle for goods and services where the Acquiring Locations are associated with a plurality of Clients within the Host System database, thereby allowing Card usage at a plurality of Client Locations where Cardholders may gain various incentives for Card usage based on a plurality of Program Groups.

In another embodiment, the Card Programs are developed to achieve a singular purpose for a singular Client. Such Card Programs are similar to the traditional Stored Value programs found in the art today except that with the invention described herein Clients have the ability to, at any time, rapidly modify in a plurality of ways the Card Programs with any other features available via the Host System. For example, a rolled out Client non-reloadable gift Card Program can, within minutes, be modified to allow for reloadability of value and to reward Cardholders for continued usage in a variety of ways without recalling or reissuing Cards.

In another embodiment, the Host System is utilized by Clients to achieve deployment of robust affinity Card Programs, where a singular Card Type may be presented at a plurality of Acquirers where the Acquirers provide varying incentive values configured with Program Groups for Cardholder patronage including but not limited to discounts, rebates, charitable contributions, etc. These varying incentives values are settled by the Host System automatically between the Acquirer and the Clients designated third party on a configurable schedule via ACH batch file transmissions.

In another embodiment, the Host System is utilized by Clients to develop, deploy, manage, and maintain Card Programs designed to be primarily reloadable ATM/Debit cards sold through established distribution channels that may or may not provide for additional Transaction Sets and/or companion cards. The Clients utilize the Host System to configure the Issuer, Acquirers, Distributors, and Agents involved with the Card Program. The Distributors and Agents associated with each other are configured within the Host System database so that relevant Card transaction counts are tracked by Agent and Distributor to either the Card Issuer or the Acquirer with the initial Card activation transaction, depending on Client and Distributor needs. The Agents are associated with Issuers and/or Acquirers so that the Card transaction counts can then be attributed to the Agent for commission calculations by the Distributor.

In another embodiment, Cards may be issued by a Client as a reloadable third party product Card where authorization for access to the third party services is achieved through the Host System. Some third party products may be prepaid Long distance, cellular, Internet, and insurance services. These Card Types can include any functionality available by the Host System by way of configuring the third party providers as Acquirers in the Host System, thereby allowing the third party Acquirers all the benefits of the flexible Program Grouping to Acquirer. Each third party Acquirer can associate with a plurality of Card Types within the Host System. Further, third party Acquirers can be grouped together allowing Clients rapid development of customizable third party services Card Programs.

In another embodiment, the some or all of the Program Group Location specific data elements and processing logic could be contained in the Point of Sale Terminal devices computer memory or storage device and Terminal software programs containing instructions to process Transaction Sets. This is useful where batch or off-line Card transaction processing is desired by the Client, or for any other reason a user of this invention may wish to offload some of the Transaction Set processing to the client machines, such as in PC based POS systems, verses the Host System. Modern POS Terminals and Personal Computers are being sold with ever increasing amounts of memory, thereby now making this embodiment feasible. Standard Terminal and host capture settlement methodologies can be employed as well to achieve Client needs herein.

### DETAILED DESCRIPTION OF THE INVENTION

Various embodiments of the invention are possible. This variability is the essence of the design concept. Clients have the ability to choose, by way of numerous Host System Web Interface forms, how they want their Card Programs to function. The Host System processes the transactions based on the Client choices by analyzing the choices made by the Client. This analysis produces a Transaction Set which compromises at least the parsed transaction request that came inbound to the Host System via an outside host and a transaction fee transaction. FIG. 7 shows the buildup of the Transaction Set within the Host System process. Often the Transaction Set will include one or more transactions and the associated transaction fee transactions based on the Client choices. These additional transactions are derived by Program Group configurations that are associated with an Acquiring Location and/or Issuer. Usually these additional transactions are Stored Value in nature. Because the Program Groups are named by the Client in an alphanumeric fashion and associated in a granular manner to the Client, the variations of Transaction Sets that can occur on a singular Card are only limited by the Client's design.

Clients have the ability to configure Distributors and Agents in The Host System database via the Web Interface. This is useful where Client third party distribution channels deploy Cards through Agents of Distributors and calculations of Agent residual commissions are typically based on Card transaction type counts. Often Clients may themselves be Distributors of sorts and this database hierarchy allows them to manage their sales force's commissions by using the same basic Host System structure.

The Card transaction process begins, therefore, by the Client's design, which is highly aided and implemented by the Host System Web Interface forms. A Client Issuer sets out by ordering any number of Cards from a Client specific set of card number prefixes, setting an expiration date, Cardholder Login choices, random or fixed PINs, CVV2 options, shared balances (companion cards), and a “ship to” designation which sets up the Trust Receipt process. This Host System process then generates Card numbers using a mod-10 algorithm which appends a check digit to the end of the sequential card numbers. An encrypted file is generated which contains the Card numbers, the Card expiration dates, the encrypted PIN block, and the CVV2. This file is then securely sent to a Card fulfillment center. The Trust Receipt process is completed when the Cards are delivered to the designee when Cards were ordered. No Cards can be activated until the Trust Receipt process is completed.

After Cards are ordered the Issuer chooses what Card Type to associate with a range of cards. This range is only limited to a sequential range belonging to one Issuer. The range could be one Card if desired, giving very granular availability to the Issuer. Card Types are selected from a form, giving the standard choices as defined above. New custom Card Types can be added at any time. Then, the first and last Card numbers are entered and a check is made to ensure the range is intact and that all Card numbers belong to the same Issuer. The Issuer may also choose to allow the Cards access to third party services like long distance and cellular minutes via the Web Interface and/or Host System Interactive Voice Response (IVR) utilizing standard DTMF and/or voice recognition technology.

After Card Types are chosen the Card Limits are established. Once again this is done by range of card numbers and is determined by the Issuer. Typically, the Card Limit Ranges are the same as the Card Type ranges, but Card Limit ranges may be a single Card if required by the Issuer. The Issuer has the ability to set different limits for enrolled and non-enrolled Cards. So therefore, depending on the Card Type, enrolled or non-enrolled groups of limits may be irrelevant. In some embodiments of the invention herein a Card Program will utilize both limit groups where the Card Limits increase once successful Card enrollment by the Cardholder has occurred. Card Limit types include daily ATM withdrawals, daily ATM transaction counts, daily POS spending, daily POS counts, Card balance limits, daily load limits, and maximum load amount. A check is made to ensure the Card range is intact and that all Card numbers belong to the same Issuer. In a shared balance or companion card embodiment the parent Card holder can set the limits of the companion Card.

Client Locations utilize Program Groups in the Host System to manage fees, rates, dates, dormancy periods, event transactions, and event days Transaction Sets that occur on a plurality of Card Types. A Program Group is given a unique alphanumeric name by the Client and is associated with a Card Type. Program Groups are then assigned to a plurality of Client Locations. Therefore, depending on the embodiment of the invention utilized herein virtually unlimited, rapidly designed, and easily managed Card Programs are possible depending on the Client needs.

An Acquirer is configured by the Client in the Host System for authorization to accept any or all Card Types Issued by the same Host System Client Issuer unless the Acquirer is authorized to accept a multi-Client Card Type. In this case the multi-Client Card Type code designates to the Host System a pass of the standard check of Acquirer & Issuer match of Host System Client number within the Host System database.

The Host System, after passing the transaction Acquirer/Issuer check, then proceeds to gather the relevant Program Group/s dates, rates, fees, and event days values and builds a Transaction Set. All transactions within the Transaction Set are processed based on the values from the Program Groups which are assigned granularly to the Acquirer Locations, and to the Card Issuer. Because there is only one Card Issuer but a plurality of Acquirers a singular Card transaction type may generate as many different Transaction Sets as there are Acquirer Locations.

In some embodiments of the invention, a Client may wish to utilize multiple Program Groups for a Card Type. So, within the Host System a Client will configure multiple Issuers for the purpose of managing the varying Program Groups values for the same Card Type. An example of this would be a generic ATM/Debit payroll Card Program where the Cardholder fees would vary depending on the Clients customer choices. Since all Card transactions flow through the Host System application, the advantages of this method are distinct as a Client can easily manage, upgrade, renew, etc., via the Host System Web Interface, a plurality of Card Programs and Program Groups segregating the Clients customer choices with one or more Card Types via customer driven Issuers. FIG. 5 outlines Program Groups authorization processing flow.

FIG. 1 describes the Host System processes beginning with an inbound Transaction 111, that typically will originate from a POS Terminal, a computer based POS system, or a batch file, a and routes to the Host System 100 via the Open Networks 113, Third Party Networks 112, or directly to the Host System 100. The transaction is then parsed 101 to identify the various values contained in the transaction string and perform basic Card number, expiration date, PIN, and CVV2 authorization routines. Host System 100 logic then determines the Card Type 102 from the Card number and then checks the Location/s 103 IDs related to the transaction to see if either or both Issuer 104 and Acquirer 105 are authorized on the Card Type. From there the Program Groups 106 of the authorized Locations 103 are analyzed for the held values 107 relevant to the Card Type 102 and the Program Group 106. Then the Host System 100 takes the held values 107 and combines the transaction values 108 from the initial Inbound Transaction 111 for amount, date, and transaction type to build a Transaction Set 109. The transactions making up the Transaction Set are then processed for approval or denial and the transactions are completed 110 and written to transaction history within the Host System 100 RDBMS database. 114. Finally a response 116 is sent from the Host System 100 to the Inbound Transaction 111 host.

FIG. 2 shows a typical embodiment Host System 100 database hierarchy where a plurality of Clients 200 and their Card Programs 201 are configured. This example shows a Client 200 utilizing Distributors 202 for a sales effort. It should be noted that a Client 200 may wish to establish multiple Client 200 entities to segregate sales, marketing, regional, Card Program deployments. Distributors 202 typically utilize Agents 203 as sales channel conduits. Agents 203 are therefore associated in the Host System 100 database to Client Locations 103 which can have Terminals 115. Client Card Programs tie Clients to Program Groups 106 which are tied to Client Locations 103.

FIG. 3 is a block diagram depicting a Host System 100 embodiment that shows basic hardware usage and processing flow of transaction strings 111 utilizing the five chief requirements from the string to process Transaction Sets 109 utilizing this invention; Card Type, Program Group, Transaction type, and Card number. The transactions start typically by either an Open Network Cardholder 302 by way of typically ISO bitmap messages 111.1 or a Client Acquirer 105 or Issuer 104 Acquired transaction, by various means, for a Cardholder 301 by way of Web services XML based messages 111.2. These Client Acquired transactions are often referred to in the art as closed loop transactions. The Host System 100 here utilizes a Java Native Interface 304 to parse the various inbound message formats into native strings recognized by the Application Server 305. The Application Server 305 runs all the logic to build, authorize, decline, and archive in the database 11 4 the transactions contained in the Transaction Sets 109. The Host embodiment here also utilizes an apache web server 303 to allow Clients rapid branded deployment of the Web Interface for their needs.

FIG. 4 is a flow chart describing a typical Host System 100 Client Program Group 106 authorization starting with the JNI 304 and gets parsed by software 101. The chart shows the decline path which terminates further Program Group 106 processes. If all goes well, Card Type 102 is determined then relevant Location 103 IDs are determined, for the Issuer 104 and Acquirer 105. Then the Held Values 107 are obtained from the database 114, and also some transaction values 108 from the Inbound Transaction 111 are utilized to build a Transaction Set 109. This would be, for example, where a transaction type purchase in the Inbound Transaction string 111 for a specified amount in the Inbound Transaction string 111 on an event day, Fridays from the Program group 106 gets a 10% discount from the Program Group 106 and accumulates reward points based on a Client chosen ratio from the Program Group 106. All completed transactions 110 are then written to the database 114.

FIG. 5 is a flowchart depicting a Client Card Program 201 setup. In this embodiment a Client utilizes the Web Interface 303 to define multiple choices which are stored in the Host System 100 database 11 4.

FIG. 6 is a block diagram showing a typical Distributor 600 and Agent 601 database 114 hierarchies for purposes of tracking Card Transactions to Distributors 600 and Agents 601 for royalty and commissions calculations. Agents are assigned to Locations 103 and Distributors are assigned to Clients 200. Completed Card transactions 110 are typically associated with the Acquiring Location 105, sometimes Issuer Locations 104 that activated/sold the Card, so it is known which Agent 601 Location 103 to track all Card transactions to for residual payouts based on Card transaction activities.

FIG. 7 is a case & effect diagram showing a typical Transaction Set 109 build up. This process starts with an Inbound Transaction 111 moving through the Application Server 305 processes and makes numerous checks for additional transactions required by the Program Groups 106 based on the Held Values 107 plus the transaction fees transactions from the Inbound Transactions, approval or decline 111 plus transaction fees for Program Group 106 transactions plus the original Inbound Transaction, making up the Transaction Set 109.

Therefore as shown, the Transaction Sets 109 are built based on Client choices. The Transaction Sets 109 are built by Inbound Transaction codes, Client Location 103 IDs, Card Type 102, and Program Group 106 relevant values. The transaction fee transactions as a part of the Transaction Set 109 are always calculated first to determine the instant account balances for approval or decline. A decline fee can take an account balance negative, but once an account is negative, no applicable transactions are authorized and the Transaction Set 109 unwinds itself prior to completion.

Unlike other Stored Value processes in use today where the clerk at the point of sale, aided with Terminal software coded prompts, is required to add the Stored Values to the Card account manually, a method of embodiment of the invention described herein would require no additional clerk interaction because the Stored Values parameters are held in the Host System 100 database 114 Program Groups 106 and the Transaction Set 109 is built automatically.

Host System Hardware and Software Environments

The standard methods of embodiment of the invention described herein utilize the Host System as a multiplexed Card Program management and transaction processing environment. This usually requires a High Availability, ultra secure, scalable, hardware architecture. The preferred database is Oracle RDBMS in a RAC or clustered grid configuration using SMP processors on a Linux operating system. This allows for rapid throughput, stability, scalability, and High Availability. In a true multiplexed environment, the transaction processing software resides on separate and distinct computing machine from the database machines. The preferred processing computers are IBM RISC based 64 bit AIX Unix machines in a High Availability Cluster Multi Processing configuration. The preferred transaction processing software programs code is written in the C language for stability, speed, and rapid enhancement. The preferred communications software programs code is Java for stability, cross-platform ability and inherent multi-threaded design. While this preferred architecture design is ideal, other databases, operating systems, processor types, and software programming languages may be utilized, and that it is understood that this invention is not limited to this preferred architecture and may be embodied by applications where different Host System hardware, database, and software programming languages may be utilized.

Thus, it will be understood by the embodiments described and all the subject matter herein, that it will be recognized by those of skill in the art that numerous variations, changes, substitutions, equivalents, modifications, and alternative constructions may be used without departing from the spirit of the invention. Accordingly, the above description should not be taken as limiting the scope of the invention, which is defined in the following claims and drawings.

### DESCRIPTION OF DRAWINGS

FIG. 1 is a block diagram depicting the Host System Process flow of a typical Transaction Set.

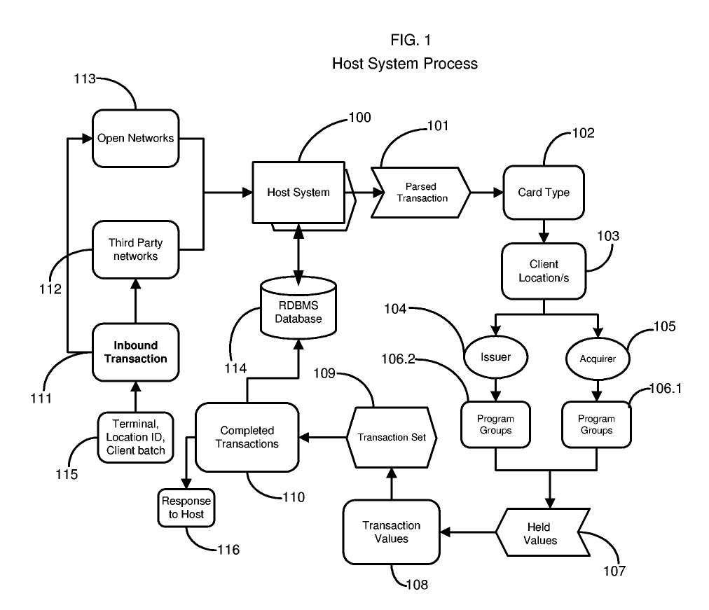

FIG. 2 shows an embodiment of a Host System database Client hierarchy.

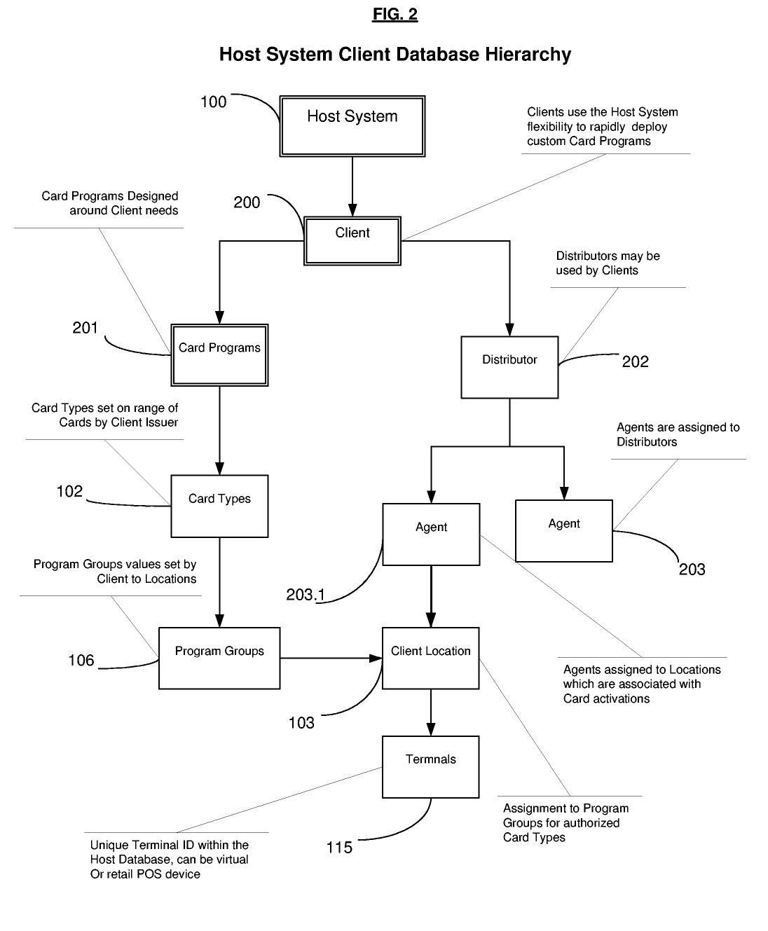

FIG. 3 details a Host System embodiment that shows basic hardware usage and processing flow of a transaction string utilizing the five chief requirements from the string to process Transaction Sets utilizing this invention; Card Type, Program Group, Transaction type, and Card number.

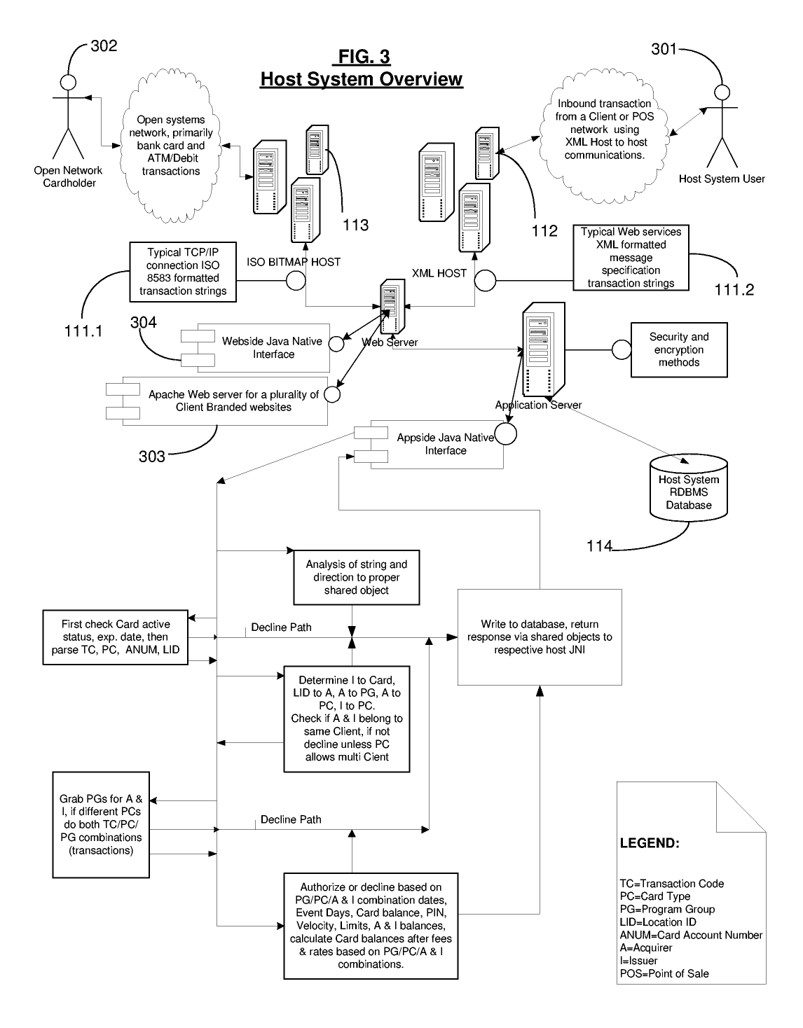

FIG. 4 shows how Program Groups are utilized to process Transaction Sets.

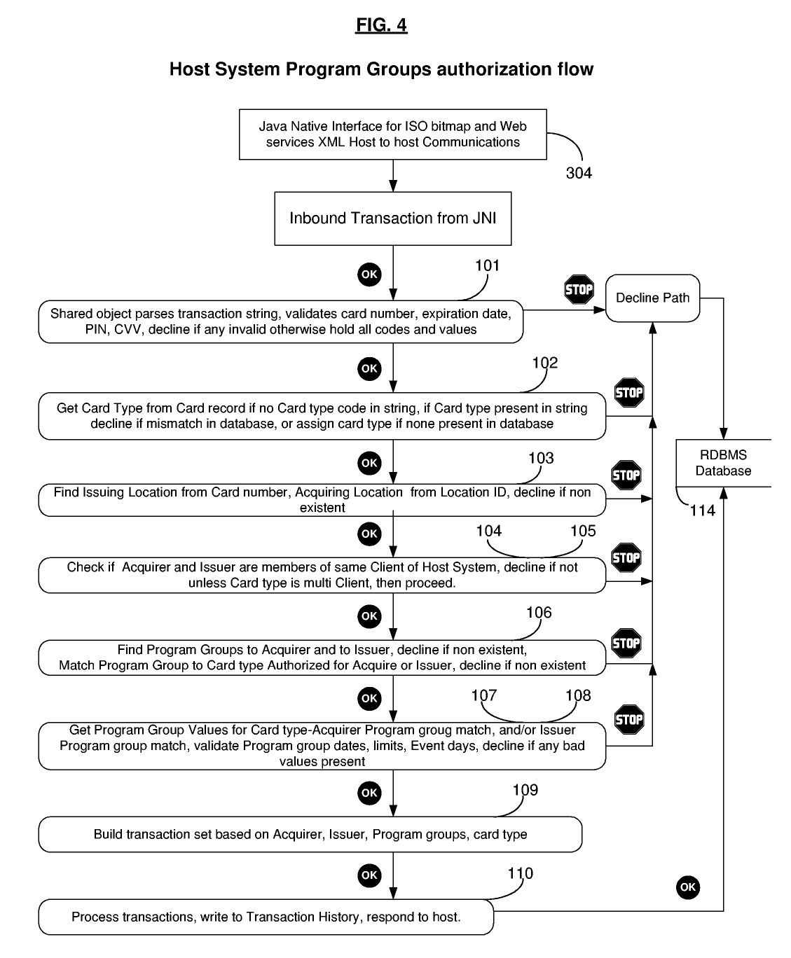

FIG. 5 shows the flow of a typical Card Program set up by Clients.

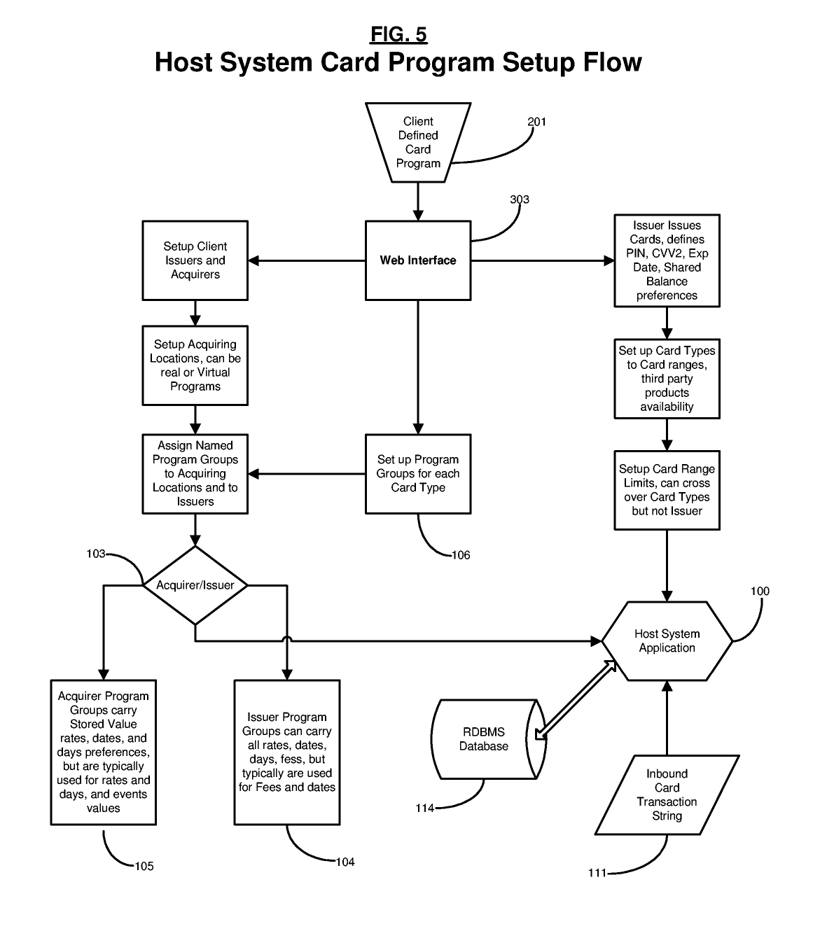

FIG. 6 details Card Distributor and Agent hierarchy.

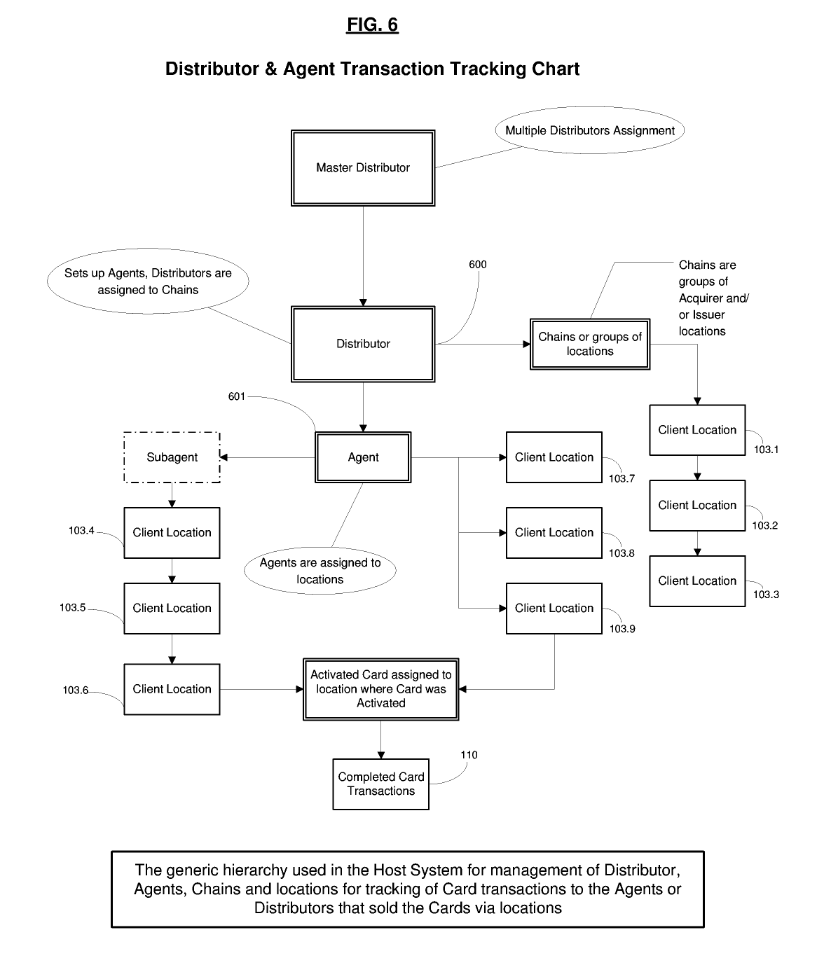

FIG. 7 outlines the basic build up of a typical Transaction Set within the Host System.

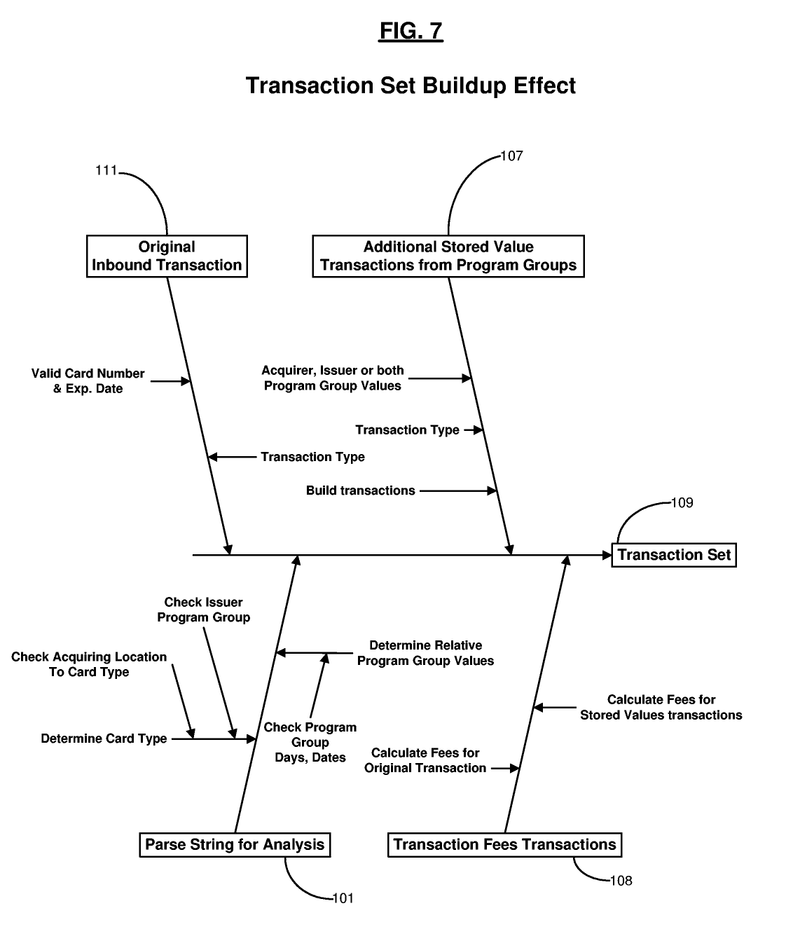

What is claimed is:

1. A method for design, deployment, and management of Card Programs and processing Card transactions where
a. a plurality of Clients, Cards, Limits, Card Types, Issuers, Acquirers, Locations, Program Groups, Terminals, Distributors, and Agents may be configured on a Host System;
b. Clients, their designees, and Cardholders having available Web Interface user forms for input, queries, and reports;
c. Inbound Transactions may be received at the Host System from a plurality of Card transaction acquiring sources, Open Networks, Third Party Networks and Terminals;
d. Issuers and Acquirers associated with a Card transaction may or may not be of the same Client configured in the Host System database;
e. Card transaction strings arriving at the Host System for processing containing data relevant to a singular transaction, (for example date, time, transaction type, amount, Card number, and Terminal ID) are captured and parsed by the Host System for proper ultimate Card Transaction Set processing based on the relevant Client choices configured in Program Groups associated with Locations;
f. Client Card Programs are configured within the Host System database typically by Card Type, Card Limits, Locations, Program Groups, and Locations.

2. The method recited in claim 1 wherein a Card is one of many Client configured Card Types within the Host System which carry different transaction type enablement, the method further enabling a plurality of Locations enablement of Card Type transactions which are received at the Host System for unique processing.

3. The method recited in claim 2 where Locations are configured in the Host System database to allow for acceptance and issuance of specified multiple Card Types which are defined in the Host System.

4. The method recited in claim 1 wherein a Client may utilize many Card Programs by assigning transaction values to Program Group entries.

5. The method recited in claim 1 wherein an Issuer is configured in the Host System database so that the Issuer is associated with a plurality of sequential Card account number ranges for the purpose of assignment of a sequential range of Card account numbers to a specific Card Type which the Issuer Issues.

6. The method recited in claim 4 wherein Client Locations may utilize many specified Card Types to grant specific or custom functions to a range of Cards. Such functions can include gift, discount, loyalty, rebate, reward, ATM/Debit, private label, multi-Acquirer, credit, event days, custom stored value, or any other Stored Value schema the Client wishes to develop.

7. The method recited in claim 5 where a Card Type functionality and transaction values are ultimately determined by Client Location utilizing named Program Group choices.

8. The method recited in claim 5 where multiple Acquirers accept the same Card Type as is issued by an Issuer when the Acquirer and Issuer are of the same Client within the Host System allowing for a plurality of Transaction Set values at a plurality of Acquirers with a single Card Type issued by an Issuer.

9. The method recited in claim 1 wherein a Card Issuer selects Card expiration dates for a range of Cards, where the Card expiration date is encoded on the Card and is only utilized for ultimate Card exhaustion when no Card Programs can function, and also for basic Card validation purposes, never for direct validation of a Transaction Set.

10. The method recited in claim 1 wherein a Card Issuer selects Card activation and Cardholder enrollment choices at the time of issuance.

11. The method recited in claim 1 wherein a Card Issuer chooses whether Cards issued have parent and companion Card privileges at the time of issuance based on a Card issuance trust ID number tied to a companion Card issuance trust ID.

12. The method recited in claim 1 where Issuers configure Cardholder fees charged to the Cardholders for various Card activities in Program Groups, and to associate Client Card transactions with a schedule of wholesale processing fees from the Host System service provider for the purpose of automated billing and accounting functions between the Client and the Host System.

13. The method recited in claim 1 where Issuers are associated with numerous Program Groups that are utilized for processing Cardholder fees specific to the Issuer, the Issuers Program Groups and Card Types.

14. The method recited in claim 1 where Acquirers are associated with Program Groups which enables proper calculation of Transaction Set values based upon the Acquirers choices.

15. The method recited in claim 1 where Card daily and maximum limits are determined for balances, usage counts, authentication failures, load amounts, daily spending and withdrawal amounts.

16. The method recited in claim 15 where Card Issuers configure numerous Card limits for a range of sequential Card numbers.

17. The method recited in claim 15 where separate Card limits are set for enrolled and non-enrolled or anonymous Cardholders within the same Card range.

18. The method recited in claim 15 where parent and companion Cards have different Card limits, yet share the same available funds, and that the companion Card limits are set by the parent Cardholder.

19. The method recited in claim 1 where Issuers are associated with Program Groups of which the Program Groups may contain fees, dates, event days, reward, loyalty, discount, rebate values, and choice of which Inbound Transaction types generate Stored Value transactions within the Transaction Set.

20. The method recited in claim 1 where Acquirers are associated with Program Groups that contain reward, loyalty, discount, and rebate values, and may also contain dates, event days, fees and choice of which Inbound Transaction type activate the Stored Value transactions.

21. The methods recited in claims 19 or 20 where Acquirers or Issuers set loyalty point rates contained within Program Groups that may be associated with a plurality of Acquirers or Issuers or both.

22. The methods recited in claims 19 or 20 where the Acquirer or Issuer sets purchase price discount rates contained within Program Groups that may be associated with a plurality of Acquirers or Issuers or both.

23. The methods recited in claims 19 or 20 where the Acquirer or Issuer sets rebate percentages of specified transactions or fixed dollar values after an event, as a function of utilizing Program Groups.

24. The methods recited in claims 19 or 20 where the Acquirer or Issuer sets Rewards rates in Program Groups that may be associated with a plurality of Acquirers or Issuers or both.

25. The methods recited in claims 19 or 20 where the Acquirer or Issuer selects up to seven days of week event days where the specified transaction associated with the Program Group is processed only on those selected days.

26. The methods recited in claims 19 or 20 where the Acquirer or Issuer selects event transactions types in the Program Groups to manage which type transactions trigger additional Stored Value transactions to be built in the Transaction Set.

27. The methods recited in claims 19 or 20 where the Issuer or Acquirer configures a funding entity Location which is charged for the values of rewards, discounts, rebates, loyalty, and points declared in the utilized Program Group.

28. The method recited in claim 1 where a scheduled Host System computer software program runs automatically on a daily basis to count the number of days since the last transaction occurred with all Cards in the Host System database and analyzing all the valid Program Groups and setting a flag in the Card database table designating the Cards as inactive if in fact the Cards have had no activity for the specified period of days configured in the Program Group associated with the Issuer and the inactive Cards, thereby triggering dormancy fees based on the Issuers time period choice.

29. The methods recited in claim 22 where the Acquirer or Issuer selects whether purchase discounts are added to the Card balance or deducted from the purchase price of the goods or services.

30. The methods recited in claim 26 whereby daily funding entity dollar amounts are automatically debited out of a designated account via a Host System automated computer software program that totals up the daily values of the relevant Stored Value transactions associated with the funding entity Locations and submits an ACH debit transaction for settlement via an ACH credit to the Clients designee which may be an entity such as a charity, marketing company, vendor, etc.

31. The method recited in claim 1 where Locations are configured within the Host System database for enablement of maintenance, support, accounting, settlement, and association with Program Groups containing Card transaction values choices.

32. The method recited in claim 30 where Card transaction Acquirers maintain daily Card loadability limits at a Location level so that as Cards are credited/loaded by the Acquirer Location, the daily Acquirer Location available loads limit is reduced by the load amounts till the limit is reached and the daily load ability is depleted.

33. The method recited in claim 30 where the daily loads of Locations are batched and processed automatically by a Host System computer software program that utilizes Acquirer data held in the Host System database to build an ACH file to be processed for settlement and the Acquiring store daily load limits replenished upon a designated time frame.

34. The method recited in claim 1 where Client Program Groups contain various dates for program definition, I.E. start, end, first enrollment, last enrollment, purge date, first distribution, initial funding, etc.

35. The method recited in claim 1 where Issuer Program Groups define a period of time, in days of inactivity, for Card dormancy to occur, thereby triggering Card dormancy fees.

36. The method recited in claim 1 where the Location Terminals may contain Program Group data elements and logic which build some Transaction Set values, by means of client software residing on the Terminals which ultimately communicate a transaction string to the Host System that may contain one or more Program Group values.

37. The method recited in claim 1 where Clients brand the Host System for their use of the Web Interface with their graphic design, logos, color schemes, fonts, and menu style with their registered Internet domain names, so the Clients can give their customers Distributors, Agents, Cardholders, and any other authorized Client designee a seamless Web Interface experience.

38. The method recited in claim 37 where the Host System database holds specific values for branded Client users of the Web Interface that limit user access of the Host System to the Clients specific Web Interface and data.

39. The method recited in claim 1 where Acquirer Locations configure Terminals used in Acquirer Locations which send a transaction string ultimately to the Host System via Third Party Networks utilized by the Client.

40. The method recited in claim 39 where Terminal configurations utilize a unique Location ID number that allows the Host System to identify the Acquiring Location.

41. The method recited in claim 40 where each Acquiring Location can configure a plurality of Terminals in the Host System that are uniquely identified at that Location for the purposes of managing transaction activity and clerk usage of the Terminal.

42. The method recited in claim 1 where Cards are activated based on Issuer choices. Cards may be activated with a code sent in a transaction string received at the Host System from an Acquirer, they may be batch activated, they may be issued Active but unloaded, they may be activated via a telephone call to a Host System Interactive Voice Response that is called by the Cardholder and prompted by the IVR with an Issuer defined activation sequence.

43. The method recited in claim 1 where the Host System parses a Inbound Transaction string from a plurality of Third Party Networks in a variety of ISO standards and XML formats for transaction type determination, validation or rejection based on relevant data contained in the Host System database about the Card, the Client, Acquirer, Issuer, and their respective Program Groups for the Card Type, and process the transactions accordingly.

44. The method recited in claim 43 where multiple new Card transactions may occur and be added to the Transaction Set if the transaction string contains codes that based on the Acquirer and Issuers Program Group values, call for additional Stored Value transactions.

45. The method recited in claim 43 where multiple additional Card transactions may occur when a Card Type code is passed in with the transaction string from an Acquirer which is authorized to accept said Card Type, yet the Issuer has set the Card Type in the aforementioned transaction string to be a different Card Type; when the Card Type codes match, only one Program Group values transaction occurs, when the Card Type codes are different and the Acquirer is authorized to accept both Card Types then two Stored Value transactions are added to the Transaction Set.

46. The method recited in claim 1 where the Host System calculates Cardholder fees based on transaction codes contained in the Inbound Transaction string and Issuer Program Group settings for that Card Type, to get the value to deduct from the Cardholder balance prior to authorization of transactions, and then posting the appropriate fee transaction details in the Host System database based on the authorization outcome of the transaction string request.

47. The method recited in claim 1 where the Host System builds Stored Value transactions and ads them to the Transaction Set based on the Client Program Groups values for the specified Card Type contained in the Inbound Transaction string received by the Host System.

48. The method recited in claim 1 where Cardholder enrollment data is stored in the Host System database for U.S. Government O.F.A.C and Patriot act “know your account” laws compliancy.

49. The method recited in claim 48 where Cardholder enrollment ID validation is accomplished through utilization of the Host System Web Interface forms that are filled out by enrollees and/or Client designees, then where the data is stored in the Host System database for submission in real time to a third party ID validation source and then the pass/fail results of the ID validation submission is published in real time back to the Web Interface user. The enrollee data is batch processed daily by a Host System computer software program and then the Pass batch submitted to a third party Card fulfillment source. The Fail batch can be processed by a Host System computer software program to generate application failure notices to the Cardholder to be sent by US Postal Service, or email.

50. The method recited in claim 1 where Client support personnel utilize the Host System Web Interface forms for Problem Tracking and resolution data held in the Host System database that captures and stores User ID, date and time, Card information, user comments, severity level, and user key words. Retrieval of Problem tickets can be queried by ticket number, Card information, severity level, User ID, and date, or a combination of those items for follow up or management review.

51. The method recited in claim 1 where Distributors are able to track Agent to Card transaction counts for commission and royalty calculations purposes by associating the Location of initial Card Activation to the Agent. This enables Distributors to manage inactive Card inventories without pre assignment of Cards to Agents.

52. The method recited in claim 1 where Issuer support personnel utilize a Host System generated Trust Receipt number for tracking shipment and receipt of Cards issued by them. The Trust Receipt number is unique within the Host System and is tied to the sequential number of Cards that are ordered via the Host System Web Interface with the Card ordering Issuer choices. The Cards are not available in the Host System for activation until the Trust Receipt process is completed and the Card shipment is designated complete by a support user, whose ID is recorded on in the Trust Receipt data.

53. The method recited in claim 1 where the Host System receives streaming real time transaction strings containing relevant data to process Card transactions properly based upon Client choices for certain Card Types and Program Groups. This host to Host System connectivity is accomplished with TCP/IP or legacy protocols, utilizing ISO formatted bitmap, and/or XML character messages.

54. The method recited in claim 53 where the Host System receives Open Network transaction requests via direct TCP/IP or legacy protocol connection or gateway to a direct connection TCP/IP or legacy protocol between the Host System and the Open Networks, where these transaction requests carry varied amounts of relevant data to process the transaction properly based on Client choices.

55. The method recited in claim 54 where the Host System receives a transaction string from the Open Networks containing a merchant Terminal ID, where the Terminal ID in the Open Network string is related to an Acquirer Location ID configured in the Host System database, where a positive match is then used by the Host System to build additional transactions in the transaction set as configured in the Acquirer Location Program Group for the Card Type if the Acquiring Location is authorized to accept the Card Type for the additional transaction set being processed. Additional Acquiring Location validation can be utilized if needed where the street number in the merchant address field of the open network transaction string matches with the street number of the Acquiring store in the Host System.

56. The method recited in claim 53 where the Host System receives a transaction string from the Open Networks containing a Merchant Category Code or MCC numeric value that is associated with a merchant type within the Host System database. The Host System may utilize this value in a variety of ways as determined by the Client in Program Group configurations associated with Acquirers and Issuers to filter transactions within Transaction Sets and process accordingly.

57. The method recited in claim 56 where an Issuer utilizes a Program Group to manage, and filter Card usage at certain merchants. An Issuer can also apply specific Stored Value transactions to the transaction set based on the MCC.

58. The method recited in claim 57 where a Client can set up a plurality of Issuers for a plurality of Card Programs utilizing the MCC to manage a plurality of values within the Program Groups that will be utilized based on Issuer of the Card number in the Inbound Transaction string from the open networks.

59. A computer-readable storage medium having a computer-readable program embodied therein for directing operation of the Host System including a communications system, a processor, and a storage device, wherein the computer-readable program includes instructions for operating the Host System to process Card transactions in accordance with the following
a. receiving, with the communications system, a transaction string in either bitmap or XML characters; receiving, with the communications system, fields within the transaction string that may contain codes to be interpreted by the computer-readable program that define the transaction type, the Card Type, the Card, the Acquirer, the Card Issuer, transaction values, transaction time, transaction ID or trace number, size of transaction string, Cardholder Personal Identification Numbers (PINs), Card expiration date, merchant location information, and Cardholder Verification Values (CVV);
b. receiving, with the communications system, a transaction string that cannot be processed due to data contained therein that the host computer readable program determines is invalid based on the transaction type and data contained within the storage device.

60. The computer-readable storage medium recited in claim 59 wherein the computer-readable program further includes instructions for reading the transaction string fields values and comparing those fields values with associated values within the storage device for authentication, validation, and storage and retrieval of data to complete the transaction process.

61. The computer-readable storage medium recited in claim 59 wherein the computer-readable program further includes instructions for analyzing and filtering the transaction string fields values with data contained in the storage device so that the computer-readable program can process the transaction string based on Card number, Card Type, Transaction type, Location, and Program Group values to build a Transaction Set that may contain other transactions written to it by the computer-readable program if the relative Program Groups so specify and that if approved, comprises at least the Inbound Transaction requested and the transaction fee transaction.
